(19) United States
(12) Patent Application Publication
(10) Pub. No.: US 2026/0153746 A1
(43) Pub. Date: Jun. 4, 2026

(54) OPTICAL SYSTEM AND NEAR-EYE DISPLAY DEVICE

(71) Applicants: Beijing Zitiao Network Technology Co., Ltd., Beijing (CN); LEMON INC., Grand Cayman (KY)

(72) Inventors: Zhao ZHANG, Beijing (CN); Yao TIAN, Beijing (CN); Ziyang ZHANG, Los Angeles, CA (US); Shaopeng ZHU, Beijing (CN); Xin LI, Beijing (CN); Xiaokai LI, Beijing (CN)

(21) Appl. No.: 19/365,922

(22) Filed: Oct. 22, 2025

(30) Foreign Application Priority Data
Nov. 29, 2024 (CN) 202411746069.9

(51) Int. Cl. G02B 27/14; G02B 1/08; G02B 1/11; G02B 27/01; G02B 27/28

(52) U.S. Cl. CPC G02B 27/142; G02B 1/08; G02B 1/11; G02B 27/0172; G02B 27/28

(57) ABSTRACT

An optical system and a near-eye display device are provided. The optical system includes an optical assembly and a light-transmitting assembly. The optical assembly includes a lens structure and a beam splitting film, a reflective polarizing film, a first phase retardation film and a first linear polarizing film on the lens structure. The reflective polarizing film and the first phase retardation film are both between the first linear polarizing film and the beam splitting film. The light-transmitting assembly is on a side of the first linear polarizing film away from the beam splitting film. The light-transmitting assembly is configured for transmitting different parts of external ambient light to human eyes and the optical assembly. The light-transmitting assembly includes a second linear polarizing film. An absorption axis of the second linear polarizing film is orthogonal to an absorption axis of the first linear polarizing film.

The present application claims priority of Chinese Patent Application No. 2024117460699, filed on Nov. 29, 2024, the disclosure of which is incorporated herein by reference in its entirety as part of the present application.

### TECHNICAL FIELD

Embodiments of the present disclosure relate to an optical system and a near-eye display device.

### BACKGROUND

With the development of science and technology, near-eye display devices, such as virtual reality (VR) display devices, are gradually developing towards “light weight” and “environmental interaction”. The open-wearing virtual reality display device can greatly improve the user's experience.

When the near-eye display device is worn in front of a user's eye, the image light displayed by the display device may travel through the optical system and be directed to the human eye. When the user wears the open-wearing near-eye display device, the surroundings of the human eyes are not closed by shading, and thus external interference light is easily reflected in the optical system to form stray light, a light spot or strong background light, etc., which is superimposed with the image light emitted by the display to interfere with the human eyes to view a normal display image.

### SUMMARY

The present disclosure provides an optical system and a near-eye display device.

The present disclosure provides an optical system, which includes an optical assembly and a light-transmitting assembly. The optical assembly includes a lens structure and a beam splitting film, a reflective polarizing film, a first phase retardation film and a first linear polarizing film provided on the lens structure, the reflective polarizing film and the first phase retardation film are both located between the first linear polarizing film and the beam splitting film; image light transmitted through the beam splitting film is configured for being folded back between the beam splitting film and the reflective polarizing film and being exited from the reflective polarizing film; the lens structure includes at least one optical lens; the light-transmitting assembly is spaced apart from the optical assembly, at least part of the light-transmitting assembly is located on a side of the first linear polarizing film away from the beam splitting film; the light-transmitting assembly is configured for transmitting different parts of external ambient light to human eyes and the optical assembly, respectively. The light-transmitting assembly includes a second linear polarizing film; and an absorption axis of the second linear polarizing film is orthogonal to an absorption axis of the first linear polarizing film.

For example, according to an embodiment of the present disclosure, the optical assembly further includes an anti-reflective film on the lens structure; and the anti-reflective film is located on a side of the first linear polarizing film away from the beam splitting film.

For example, according to an embodiment of the present disclosure, the light-transmitting assembly further includes a light-transmitting support; and the second linear polarizing film is disposed on a side of the light-transmitting support facing the optical assembly.

For example, according to an embodiment of the present disclosure, the optical assembly further includes a second phase retardation film located on the lens structure; the second phase retardation film is located on a side of the first linear polarizing film facing the second linear polarizing film; and an included angle between a slow axis of the second phase retardation film and an optical absorption axis of the first linear polarizing film is 45 degrees; the light-transmitting assembly further includes a third phase retardation film located on a side of the second linear polarizing film facing the second phase retardation film; and a slow axis of the third phase retardation film is orthogonal to the slow axis of the second phase retardation film.

For example, according to an embodiment of the present disclosure, the optical assembly further includes an anti-reflective film on the lens structure; and the anti-reflective film is located on a side of the second phase retardation film away from the beam splitting film.

For example, according to an embodiment of the present disclosure, the light-transmitting assembly further includes a light-transmitting support; and the second linear polarizing film and the third phase retardation film are both located on a side of the light-transmitting support facing the optical assembly.

For example, according to an embodiment of the present disclosure, the optical system is in a state of displaying an image; and an optical axis of the lens structure does not pass through the light-transmitting assembly.

For example, according to an embodiment of the present disclosure, the light-transmitting assembly is configured for being movable with respect to the optical assembly.

For example, according to an embodiment of the present disclosure, a light transmission of the light-transmitting support is greater than 95%.

For example, according to an embodiment of the present disclosure, an air space is provided between the optical assembly and the light-transmitting assembly.

Another embodiment of the present disclosure provides a near-eye display device, including any optical system as mentioned above, the near-eye display device is an open-wearing near-eye display device.

For example, according to an embodiment of the present disclosure, the near-eye display device includes a lens and a temple; the lens includes the optical assembly; the temple includes the light-transmitting assembly; and the temple is configured for being rotatable with respect to the lens.

For example, according to an embodiment of the present disclosure, the lens includes two sub-lenses corresponding to both eyes of a user; the temple includes a wearing portion and a widening portion; a dimension of the widening portion is greater than a dimension of the wearing portion in a reference direction perpendicular to a center line of the two sub-lenses; and the widening portion is located between the wearing portion and the lens; and the widening portion includes the light-transmitting assembly.

For example, according to an embodiment of the present disclosure, a ratio of a minimum dimension of the light-transmitting assembly in the reference direction to a maximum dimension of a lens region of the optical assembly in the reference direction is in a range from 0.8 to 1.1; and a minimum dimension of the light-transmitting assembly in an extending direction of the widening portion is not less than a maximum dimension of the lens region in a direction parallel to the center line.

For example, according to an embodiment of the present disclosure, in the extending direction of the widening portion, a ratio of a dimension of the widening portion to a dimension of the wearing portion is in a range from ¼ to 1.

For example, according to an embodiment of the present disclosure, the near-eye display device further includes a display screen located on a side of the beam splitting film away from the first linear polarizing film.

### BRIEF DESCRIPTION OF DRAWINGS

In order to clearly illustrate the technical solutions of the embodiments of the present disclosure, the drawings of the embodiments will be briefly described in the following; it is obvious that the described drawings are only related to some embodiments of the present disclosure and thus are not limitative to the present disclosure.

FIG. 1 is a schematic diagram of an optical path of reflected stray light when human eyes view a near-eye display device.

FIG. 2 is a partial structural diagram of an optical system provided according to an example of an embodiment of the present disclosure.

FIGS. 3 and 4 are partial structural diagrams of optical systems provided according to different examples of an embodiment of the present disclosure.

FIG. 5 is a schematic diagram of a near-eye display device provided according to an embodiment of the present disclosure.

FIG. 6 is a schematic diagram of a near-eye display device provided according to another example of an embodiment of the present disclosure.

FIG. 7 is a structural diagram in a lens of FIG. 5.

### DETAILED DESCRIPTION

In order to make objects, technical solutions and advantages of the embodiments of the present disclosure apparent, the technical solutions of the embodiments will be described in a clearly and fully understandable way in connection with the drawings related to the embodiments of the present disclosure. Apparently, the described embodiments are just a part but not all of the embodiments of the present disclosure. Based on the described embodiments of the present disclosure, those skilled in the art can obtain other embodiment(s), without any inventive work, which should be within the scope of the present disclosure.

Unless otherwise defined, all the technical and scientific terms used herein have the same meanings as commonly understood by one of ordinary skill in the art to which the present disclosure belongs. The terms “first,” “second,” etc., which are used in the present disclosure, are not intended to indicate any sequence, amount or importance, but distinguish various components. The terms “comprise,” “comprising,” “include,” “including,” etc., are intended to specify that the elements or the objects stated before these terms encompass the elements or the objects and equivalents thereof listed after these terms, but do not preclude the other elements or objects.

When a quantity of a component is not specifically specified in the following text of the embodiments of the present disclosure, it means that the quantity of such component may be one or more, or may be understood as at least one. The expression “at least one” refers to one or more, and “more” refers to at least two.

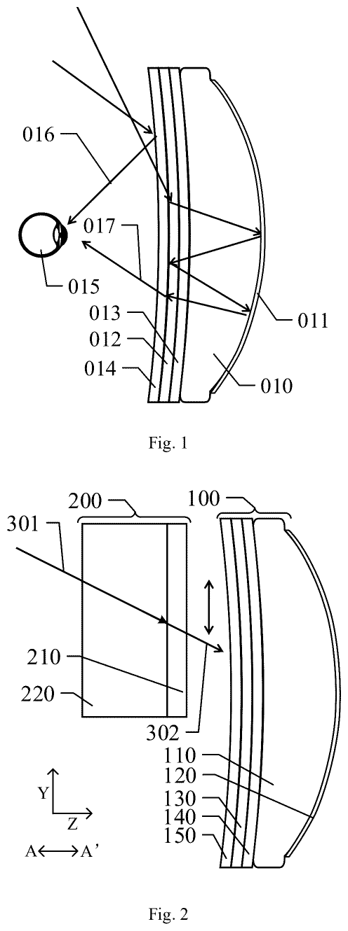

FIG. 1 is a schematic diagram of an optical path of reflected stray light when human eyes view a near-eye display device. As shown in FIG. 1, an optical system in a near-eye display device may include a folded optical system (Pancake), the folded optical system includes an optical lens 010 and a beam splitting film 011 located on the optical lens 010, a reflective polarizing film 012, a phase retardation film 013 and a linear polarizing film 014. The beam splitting film 011 is located on a side of the optical system close to a display screen (not shown). The reflective polarizing film 012 is located on a side of the optical system close to human eyes 015. The phase retardation film 013 may be located between the beam splitting film 011 and the reflective polarizing film 012, or may be located on a side of the reflective polarizing film 012 away from the beam splitting film 011. The linear polarizing film 014 is located between the reflective polarizing film 012 and the human eyes 015. The image light (not shown) emitted from the display panel is transmitted through the beam splitting film 011, then folded back between the beam splitting film 011 and the reflective polarizing film 012, and is exited from the reflective polarizing film 012 to the human eyes 015.

In the study, the inventors of the present application found that when the display device is an open-wearing near-eye display device, the glare introduced by the external environment can not be ignored. As shown in FIG. 1, external interference light 016 and 017, such as ambient stray light, for example ambient natural light, will be incident into the optical system. For example, the interference light 016 is directly reflected by the outer surface of the optical system towards the human eyes 015. After being incident into the optical system, the interference light 017 is incident into the human eyes 015 after being folded back between the beam splitting film 011 and the reflective polarizing film 012, so as to form two types of stray light. The stray light caused by the interference light 016 can be improved by adding an anti-reflective film on the surface of optical system. However, the stray light formed by the interference light 017 passes through the film layer of the optical system, which is difficult to be alleviated only by the arrangement of the anti-reflective film. If a conventional shielding member is used to shield this part of the stray light, the environmental interactivity of the open-wearing near-eye display device will be affected, namely, the shielding member shields the ambient light that should have been incident on the human eyes, thus affecting the user's interaction with the environment during the display process.

The present disclosure provides an optical system and a near-eye display device. The optical system includes an optical assembly and a light-transmitting assembly. The optical assembly includes a lens structure and a beam splitting film, a reflective polarizing film, a first phase retardation film and a first linear polarizing film provided on the lens structure. The reflective polarizing film and the first phase retardation film are both located between the first linear polarizing film and the beam splitting film. The image light transmitted through the beam splitting film is configured for being folded back between the beam splitting film and the reflective polarizing film and being exited from the reflective polarizing film. The lens structure includes at least one optical lens. The light-transmitting assembly is spaced apart from the optical assembly, at least part of the light-transmitting assembly is located on a side of the first linear polarizing film away from the beam splitting film. The light-transmitting assembly is configured for transmitting different parts of external ambient light to human eyes and the optical assembly, respectively. The light-transmitting assembly includes a second linear polarizing film. An absorption axis of the second linear polarizing film is orthogonal to an absorption axis of the first linear polarizing film.

By providing a light-transmitting assembly including a second linear polarizing film, the optical system provided by the present disclosure can prevent external interference light from being incident inside the optical assembly while realizing user interaction with the environment, effectively reducing the influence of external interference light, such as stray light, on the display effect, which is beneficial to improving the display quality and improving user experience.

The optical system and the near-eye display device provided by the embodiments of the present disclosure will be described below with reference to the accompanying drawings.

FIG. 2 is a partial structural diagram of an optical system provided according to an example of an embodiment of the present disclosure.

As shown in FIG. 2, the optical system includes an optical assembly 100 and a light-transmitting assembly 200. The optical assembly 100 includes a lens structure 110 and a beam splitting film 120, a reflective polarizing film 130, a first phase retardation film 140 and a first linear polarizing film 150 provided on the lens structure 110. The reflective polarizing film 130 and the first phase retardation film 140 are located between the first linear polarizing film 150 and the beam splitting film 120. The image light transmitted through the beam splitting film 120 is configured for being folded back between the beam splitting film 120 and the reflective polarizing film 130 and being exited from the reflective polarizing film 130. The lens structure 110 includes at least one optical lens.

For example, as shown in FIG. 2, the beam splitting film 120 may be a beam splitter (BS) configured to transmit a part of the light and reflect another part of the light. For example, the beam splitting film 120 can include at least one film layer, e. g., each film layer can have a thickness in the range of 10 to 200 nanometers. For example, the beam splitting film 120 may have a transmittance of 50% and a reflectance of 50%. For example, the beam splitting film 120 may have a transmittance of 60% and a reflectance of 40%. For example, the beam splitting film 120 may have a transmittance of 65% and a reflectance of 35%. The embodiments of the present disclosure are not limited thereto, and the transmittance and the reflectance of the beam splitting film 120 may be set according to product requirements.

For example, as shown in FIG. 2, the reflective polarizing film 130 may be a reflective polarizer (RP) configured for reflecting linearly polarized light of one characteristic and transmitting linearly polarized light of another characteristic.

For example, as shown in FIG. 2, the reflective polarizing film 130 functions as follows. There is a light-transmitting axis direction in the plane of the film layer. The transmittance of the polarization component (e. g., s-linearly polarized light) of the incident light parallel to the light-transmitting axis direction is greater than the transmittance of the polarization component perpendicular to the light-transmitting axis direction (e. g., p-linearly polarized light). The reflectance of the polarization component (e. g., s-linearly polarized light) parallel to the light-transmitting axis direction is less than the reflectance of the polarization component (e. g., p-linearly polarized light) perpendicular to the light-transmitting axis direction. For example, the transmittance of polarized light in the direction parallel to the light-transmitting axis of reflective polarizing film 130 is not less than 85%, such as not less than 90%, such as not less than 95%, or such as not less than 98%. The reflectance of polarized light in the direction perpendicular to the light-transmitting axis of the reflective polarizing film 130 is not less than 85%, such as not less than 90%, such as not less than 95%, or such as not less than 98%.

For example, as shown in FIG. 2, the first phase retardation film 140 is configured such that the transmitted light realizes a transition between a circular polarization state and a linear polarization state. For example, the first phase retardation film 140 may be a quarter-wave plate (QWP). For example, the material of the first phase retardation film 140 may include a liquid crystal polymer or a polycarbonate. For example, the first phase retardation film 140 has the following characteristics. In the plane of the film, there are a direction with the lowest refractive index and a direction with the highest refractive index, which are the fast axis and the slow axis, respectively. The phase of the polarized light parallel to the slow axis after passing through the phase retardation film is delayed by ¼ wavelength than that of the polarized light parallel to the fast axis after passing through the phase retardation film.

For example, as shown in FIG. 2, the angle between the slow axis of the first phase retardation film 140 and the light-transmitting axis of the reflective polarizing film 130 is 45 degrees.

For example, as shown in FIG. 2, the first linear polarizing film 150 may be a linear polarizer. The light-transmitting axis of the first linear polarizing film 150 coincides with the light-transmitting axis of the reflective polarizing film 130. For example, the first linear polarizing film 150 may be used to further filter other stray light and allow only the polarized light (e. g., s-polarized light) passing through the first linear polarizing film 150 to enter the human eye.

For example, as shown in FIG. 2, the YZ plane may be a cross-section taken through the optical assembly 100, with the optical axis of the lens structure 110 parallel to the Z direction. For example, the direction perpendicular to the YZ plane and pointing to the paper plane is the X direction, and the direction of the slow axis of the first phase retardation film 140 is a counterclockwise rotation of 45 degrees at 0 degrees in the X direction. For example, the angle of the slow axis is 45 degrees. The reflection axis of the reflective polarizing film 130 is parallel to the Y direction, for example, rotating counterclockwise by 90 degrees at 0 degrees in the X direction. For example, the angle of the reflection axis is 90 degrees. The absorption axis of the first linear polarizing film 150 is parallel to the Y direction, e. g., rotating 90 degrees counterclockwise by 0 degrees in the X direction. For example, the angle of the absorption axis is 90 degrees. For example, the first phase compensation film 140 has an angle θ1 with respect to the X direction, the reflective polarizing film 130 has an angle θ2 with respect to the X direction, and the angle between θ1 and θ2 is 45 degrees, not limited to ±45 degrees. The light-transmitting axis of the first linear polarizing film 150 is parallel to the light-transmitting axis of the reflective polarizing film 130.

For example, as shown in FIG. 2, the beam splitting film 120 and the reflective polarizing film 130 serve as two reflecting surfaces to provide an ultra-short focal folded light path (Pancake). For example, the arrangement of the beam splitting film 120 and the reflective polarizing film 130 enables the light to be folded so that the focal length of the optical system is folded due to the increased, e. g., two, reflections caused by the arrangement of the reflective polarizing film 130 and the beam splitting film 120, thereby greatly compressing the space required between the human eyes and the optical system, thereby making the optical system smaller and thinner.

As shown in FIG. 2, the lens structure 110 includes at least one optical lens.

For example, FIG. 2 schematically illustrates that lens structure 110 includes one optical lens, the beam splitting film 120 is located on one surface of the optical lens, and the first phase retardation film 140, the reflective polarizing film 130, and the first linear polarizing film 150 are located on the other surface of the optical lens, but is not limited thereto. The lens structure 110 may include a plurality of optical lenses, and the beam splitting film 120 and the reflective polarizing film 130 may be located on different surfaces of the same optical lens or on surfaces of different optical lenses. The embodiments of the present disclosure are not limited thereto. For example, the beam splitting film 120 may be plated on the surface of the optical lens. At least one of the first phase retardation film 140 and the reflective polarizing film 130 may be attached to the surface of the optical lens by an optical adhesive. For example, the first phase retardation film 140 is attached to the surface of the optical lens. The reflective polarizing film 130 is attached to the surface of the first phase retardation film 140 away from the beam splitting film 120. The first linear polarizing film 150 is attached to the surface of the reflective polarizing film 130 away from the beam splitting film 120.

For example, as shown in FIG. 2, the surface of the lens structure 110 on which the first linear polarizing film 150 is provided may be a curved surface. The first phase retardation film 140, the reflective polarizing film 130 and the first linear polarizing film 150 provided on the curved surface may each be a film layer having a curved surface shape. Of course, the embodiments of the present disclosure are not limited thereto. The lens surface on which at least one of the first phase retardation film 140, the reflective polarizing film 130, and the first linear polarizing film 150 is provided may also be a plane. The film layer provided on the plane is formed as a film layer having a planar shape.

As shown in FIG. 2, the light-transmitting assembly 200 is spaced from the optical assembly 100. At least a portion of the light-transmitting assembly 200 is located on a side of the first linear polarizing film 150 away from the beam splitting film 120. The light-transmitting assembly 200 is configured to transmit a part of the ambient light (the ambient light 304 as shown in FIG. 5) to human eyes, and to transmit a part 301 of the ambient light to the optical assembly 100.

In some examples, as shown in FIG. 2, an air space is provided between the optical assembly 100 and the light-transmitting assembly 200. By providing the air space between the optical assembly 100 and the light-transmitting assembly 200, for example, having a certain distance between the light-transmitting assembly 200 and the optical assembly 100, the image light exited from the optical assembly 100 is prevented from passing through the light-transmitting assembly 200 and then being emitted to the human eyes.

As shown in FIG. 2, the light-transmitting assembly 200 includes a second linear polarizing film 210 having an absorption axis orthogonal to an absorption axis of first linear polarizing film 150. The external ambient light passes through the second polarizing film, emerging as linearly polarized light, and a part of the linearly polarized light is incident on human eyes (as shown in FIG. 5, the linearly polarized light 305), so as to realize the interaction between a user and the environment. When another part 302 of the linearly polarized light is incident on the optical assembly 100, e. g., on the first linear polarizing film 150 in the optical assembly 100, because the absorption axis of the first linear polarizing film 150 is orthogonal to the absorption axis of the second linear polarizing film 210, this part 302 of the linearly polarized light is absorbed by the first linear polarizing film 150 and does not propagate further into the interior of the optical assembly 100, e. g., is cut off at the first linear polarizing film 150.

The light-transmitting assembly 200 of the optical system arrangement provided by the present disclosure is configured for converting the polarization state of ambient light incident on the optical assembly 100.

The optical system provided by the present disclosure can prevent external interference light from being incident into the interior of the optical assembly 100 while realizing user interaction with the environment by providing the light-transmitting assembly 200, and the second linear polarizing film 210 in the light-transmitting assembly 200 being matched with the first linear polarizing film 150 in the optical assembly 100, effectively reducing the influence of external stray light on the display effect, which is beneficial to improving the display quality and improving user experience.

For example, as shown in FIG. 2, the second linear polarizing film 210 may be a linear polarizer. The absorption axis of the second linear polarizing film 210 is parallel to the X direction, e. g., the angle of the absorption axis is 0 degrees, the polarization direction of the linearly polarized light 302 transmitted after the external ambient light 301 passes through the second linear polarizing film 210 is parallel to the Y direction, e. g., the linearly polarized light is vertically linearly polarized light.

In some examples, as shown in FIG. 2, the light-transmitting assembly 200 further includes a light-transmitting support 220. The second linear polarizing film 210 is disposed on a side of the light-transmitting support 220 facing the optical assembly 100. The second linear polarizing film 210 is disposed on a side of the light-transmitting support 220 facing the optical assembly 100, which is advantageous for realizing the protection of the second linear polarizing film 210 by the light-transmitting support 220, and preventing the second linear polarizing film 210 from being affected by friction, scratch, etc., on the light-transmitting effects. Of course, the embodiments of the present disclosure are not limited thereto. The second linear polarizing film 210 may also be located on a side of the light-transmitting support 220 away from the optical assembly 100.

For example, as shown in FIG. 2, the second linear polarizing film 210 may be attached to the light-transmitting support 220. For example, the second linear polarizing film 210 may be attached to the light-transmitting support 220 by roller or vacuum pressure. For example, the second linear polarizing film 210 may be attached to light-transmitting support 220 by optical glue, glue, or the like.

In some examples, as shown in FIG. 2, the light transmission of the light-transmitting support 220 is greater than 95%. For example, the light transmission of the light-transmitting support 220 is greater than 96%. For example, the light transmission of the light-transmitting support 220 is greater than 97%. For example, the light transmission of the light-transmitting support 220 is greater than 98%. For example, the light transmission of the light-transmitting support 220 is greater than 99%. The embodiments of the present disclosure do not exemplify the light transmittance of the light-transmitting support 220, and the greater the light transmittance of the light-transmitting support 220, the more favorable the user's interaction with the environment.

For example, as shown in FIG. 2, the material of the light-transmitting support 220 includes a transparent material such as polymethyl methacrylate (PMMA) or a resin material. For example, after a film layer such as the second linear polarizing film 210 is provided on the light-transmitting support 220, the brightness of the light transmission may decrease, e. g., decrease by more than 20%, e. g., decrease by more than 30%, e. g., decrease by 40%. For example, the light passing through the light-transmitting support 220 does not have polarized light characteristics, such as unpolarized light.

In some examples, as shown in FIG. 2, the light-transmitting assembly 200 is configured for being movable with respect to the optical assembly 100. For example, taking the fixed position of the optical assembly 100 as an example, the light-transmitting assembly 200 can be moved towards or away from a side of the optical assembly 100, e. g., the light-transmitting assembly 200 can be movable relative to the optical assembly 100 along an arc path, e. g., the end of the light-transmitting assembly 200 close to the optical assembly 100 can be fixed in position relative to the optical assembly 100, and the end of the light-transmitting assembly 200 away from the optical assembly 100 can be moved relative to the optical assembly 100 along an arc path towards or away from the optical assembly 100.

For example, FIG. 2 schematically illustrates a cross-sectional view of the light-transmitting assembly 200 moving directly in front of the optical assembly 100 to clearly illustrate the case that the incidence of light rays exiting the light-transmitting assembly 200 on the optical assembly 100. The dimensional relationship of the optical assembly 100 and the light-transmitting assembly 200 in FIG. 2 in the Y direction and the Z direction does not represent the dimensional relationship of the optical assembly 100 and the light-transmitting assembly 200 in an actual product.

In some examples, the optical system is in a state in which an image is displayed, and the optical axis of the lens structure does not pass through the light-transmitting assembly. The case where the optical system is in a state of displaying an image may be a case where a user uses the optical system, in which case the optical axis of the lens structure does not pass through the light-transmitting assembly so as to prevent the light-transmitting assembly from obstructing image light incident on the human eyes and affecting the user's viewing of a display screen. For example, the optical system shown in FIG. 2 may be such that the optical system is not worn by the user. When the optical system shown in FIG. 2 is worn by the user, the light-transmitting assembly 200 moves towards a side away from the optical assembly 100 so as to avoid blocking the image light exited from the optical assembly 100 to the human eyes. Of course, FIG. 2 may also be a cross-section taken along the line AA′ shown in FIG. 5 (described later), in which case the optical system may also be worn by the user. For example, when the optical system is in a state of displaying an image, the optical axis of the lens structure does not pass through the light-transmitting assembly.

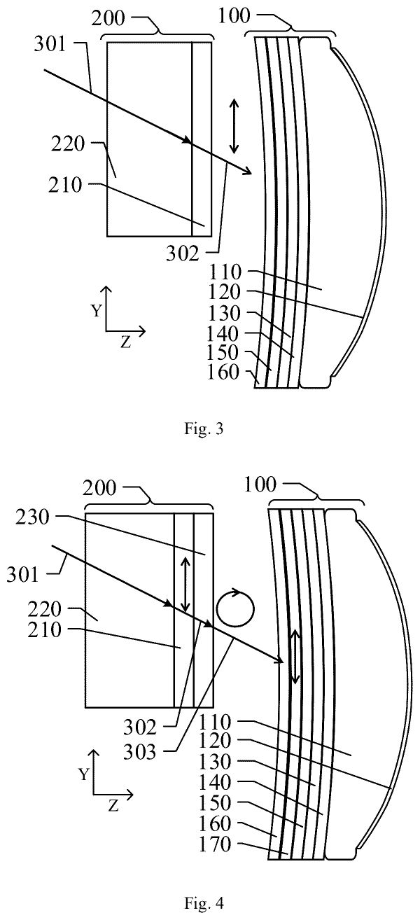

FIGS. 3 and 4 are partial structural diagrams of optical systems provided according to different examples of an embodiment of the present disclosure.

The optical system in the example shown in FIG. 3 differs from the optical system shown in FIG. 2 in that the optical assembly 100 further includes an anti-reflective (AR) film 160 on the lens structure 110, the anti-reflective film 160 is located on a side of the first linear polarizing film 150 away from the beam splitting film 120. The anti-reflective film 160 is disposed on a side of the first linear polarizing film 150 facing the external environment to reduce the part of the external ambient light reflected by the optical assembly 100 towards the human eye, such as the ambient light 016 shown in FIG. 1, to further reduce stray light.

As shown in FIG. 3, the external ambient light passes through the second linear polarizing film 210, emerging as linearly polarized light, and a part of the linearly polarized light is incident on the human eyes, so as to realize the interaction between a user and the environment. The other part 302 of the linearly polarized light is incident on the optical assembly 100. For example, when the linearly polarized light is incident on the anti-reflective film 160 in the optical assembly 100, the reflected light of the linearly polarized light which is reflected to the human eyes via the surface of the anti-reflective film 160 can be reduced. The linearly polarized light transmitted through the anti-reflective film 160 to the first linear polarizing film 150 is absorbed by the first linear polarizing film 150 and does not continue to propagate into the interior of the optical assembly 100, e. g., is cut off at the first linear polarizing film 150.

In the optical system provided by the present disclosure, the light-transmitting assembly 200 is provided, and the second linear polarizing film 210 in the light-transmitting assembly 200 is matched with the first linear polarizing film 150 and the anti-reflective film 160 in the optical assembly 100, which can not only reduce the external interference light directly reflected by the optical assembly 100 towards the human eyes, but also prevent the external interference light from being incident inside the optical assembly 100, greatly reducing the influence of external stray light on the display effect, significantly improving the display quality and improving the user experience while realizing the interaction between the user and the environment.

For example, the anti-reflective film 160 may include a plurality of film layers such that the reflected light destructively interferes therein to reduce the intensity of the reflected light.

For example, as shown in FIG. 3, the anti-reflective film 160 may be attached to the surface of the first linear polarizing film 150 facing the external environment.

The structure other than the anti-reflective film 160 in the optical system shown in FIG. 3 may have the same features as those of the corresponding structure in the optical system shown in FIG. 2, and will not be described again.

The optical system in the example shown in FIG. 4 differs from the optical system shown in FIG. 2 mainly in that a second phase retardation film 170 is further disposed in the optical assembly 100, and a third phase retardation film 230 is further disposed in the light-transmitting assembly 200.

In some examples, as shown in FIG. 4, the optical assembly 100 further includes a second phase retardation film 170 on the lens structure 110. The second phase retardation film 170 is located on a side of the first linear polarizing film 150 facing the second linear polarizing film 210. The slow axis of the second phase retardation film 170 has an included angle of 45 degrees with the absorption axis of the first linear polarizing film 150.

For example, as shown in FIG. 4, the absorption axis of the first linear polarizing film 150 is parallel to the Y direction, e. g., rotated 90 degrees counterclockwise at 0 degrees in the X direction. For example, the angle of the absorption axis is 90 degrees. The included angle of the slow axis of the second phase retardation film 170 from the absorption axis of the first linear polarizing film 150 being 45 degrees may include the slow axis of the second phase retardation film 170 being rotated 45 degrees clockwise relative to the absorption axis of the first linear polarizing film 150 or the slow axis of the second phase retardation film 170 being rotated 45 degrees counterclockwise relative to the absorption axis of the first linear polarizing film 150. For example, the slow axis of the second phase retardation film 170 and the slow axis of the first phase retardation film 140 may be parallel or perpendicular.

The case where the second phase retardation film 170 is provided in the optical assembly 100 is applicable to a case where a user wears an additional lens such as myopic lens and polarizing lens, in which case, the surface of the additional lens will reflect some image light, such as stray image light, which is directed to the human eyes, back to the optical assembly 100. By providing the second phase retardation film 170, the stray image light can be converted from the circularly polarized light to the linearly polarized light, and the linearly polarized light is absorbed by the first linear polarizing film 150, so as to prevent the reflected stray image light from entering into the pancake light path between the reflective polarizing film 130 and the beam splitting film 120, thus achieving an anti-reflection effect.

In some examples, as shown in FIG. 4, the light-transmitting assembly 200 further includes a third phase retardation film 230 disposed on a side of the second linear polarizing film 210 facing the second phase retardation film 170, and the slow axis of the third phase retardation film 230 is orthogonal to the slow axis of the second phase retardation film 170.

As shown in FIG. 4, in the optical system provided by the embodiments of the present disclosure, by providing the first linear polarizing film 150 and the second phase retardation film 170 in the optical assembly 100, and also providing the second linear polarizing film 210 and the third phase retardation film 230 respectively matched with the first linear polarizing film 150 and the second phase retardation film 170 in the light-transmitting assembly 200, the external ambient light 301 passes through the second linear polarizing film 210, emerging as the linearly polarized light 302, such as the vertical linearly polarized light, and the linearly polarized light 302 is converted into circularly polarized light 303, such as the left-handed circularly polarized light by the third phase retardation film 230. The circularly polarized light is converted into linearly polarized light, such as vertically linearly polarized light, by the second phase retardation film 170. The linearly polarized light is absorbed by the first linear polarizing film 150 and does not continue to propagate into the interior of the optical assembly 100, such as being cut off at the first linear polarizing film 150. Therefore, it is possible to prevent external interference light from being incident into the interior of the optical assembly 100 while realizing user interaction with the environment, so as to effectively reduce the influence of external stray light on the display effect, which is beneficial to improving display quality and improving user experience.

For example, as shown in FIG. 4, the direction of the slow axis of the second phase retardation film 170 is located at a direction when the above-mentioned X direction is rotated counterclockwise by 45 degrees at 0 degrees. For example, the angle of the slow axis is 45 degrees. The direction of the slow axis of the third phase retardation film 230 is located at a direction when the above-mentioned X direction is rotated counterclockwise by 135 degrees at 0 degrees. For example, the angle of the slow axis is 135 degrees.

For example, as shown in FIG. 4, the second phase retardation film 170 and the third phase retardation film 230 may each be a quarter-wave plate. For example, the material of at least one of the second phase retardation film 170 and the third phase retardation film 230 may be a material that is positively dispersed with respect to the wavelength. For example, the material of at least one of the second phase retardation film 170 and the third phase retardation film 230 may be a material that is inversely dispersed with respect to the wavelength. For example, at least one of the second phase retardation film 170 and the third phase retardation film 230 may include a combination film layer of a half-wave plate and a quarter-wave plate.

In some examples, as shown in FIG. 4, the light-transmitting assembly 200 further includes a light-transmitting support 220. The second linear polarizing film 210 and the third phase retardation film 230 are both located on a side of the light-transmitting support 220 facing the optical assembly 100. The second linear polarizing film 210 and the third phase retardation film 230 are both disposed on a side of the light-transmitting support 220 facing the optical assembly 100, which is advantageous for realizing the protection of the second linear polarizing film 210 and the third phase retardation film 230 by the light-transmitting support 220, and preventing the second linear polarizing film 210 and the third phase retardation film 230 from being subjected to friction, scratch, etc. to affect the light output effect. Of course, the embodiments of the present disclosure are not limited thereto. The second linear polarizing film 210 and the third phase retardation film 230 may both be located on a side of the light-transmitting support 220 away from the optical assembly 100. Alternatively, one of the second linear polarizing film 210 and the third phase retardation film 230 may be located between the light-transmitting support 220 and the optical assembly 100, and the other may be located on a side of the light-transmitting support 220 away from the optical assembly 100.

For example, as shown in FIG. 4, after the second linear polarizing film 210 is attached to the light-transmitting support 220, the third phase retardation film 230 may be attached to the second linear polarizing film 210 or the light-transmitting support 220. For example, the second linear polarizing film 210 and the third phase retardation film 230 may be formed into a composite film and then the composite film may be attached to the light-transmitting support 220.

In some examples, as shown in FIG. 4, the optical assembly 100 further includes an anti-reflective film 160 on the lens structure 110, the anti-reflective film 160 is located on a side of the second phase retardation film 170 away from the beam splitting film 120. The anti-reflective film 160 is disposed on a side of the second phase retardation film 170 facing the external environment to reduce the part of the external ambient light that is reflected toward the human eyes through the optical assembly 100, such as the ambient light 016 shown in FIG. 1, to further reduce stray light.

The lens structure 110, the beam splitting film 120, the first phase retardation film 140, the reflective polarizing film 130, the first linear polarizing film 150, the anti-reflective film 160, the second linear polarizing film 210, and the light-transmitting support 220 in the optical system shown in this example may have the same features as the corresponding structures in the optical system shown in FIGS. 2 and 3, and will not be described in detail herein.

FIG. 5 is a schematic diagram of a near-eye display device provided according to an embodiment of the present disclosure.

As shown in FIG. 5, the near-eye display device 1000, which is an open-wearing near-eye display device 1000, includes the optical system in any of the examples described above.

As shown in FIG. 5, by providing the light-transmitting assembly 200 in the near-eye display device 1000, the user's eyes 400 can see the external ambient light 304 through the light-transmitting assembly 200 so as to enable the user to interact with the environment. At the same time, the external ambient light 301 incident on the optical assembly 100 through the light-transmitting assembly 200 is cut off at the first linear polarizing film 150 so as to prevent external interference light from being incident on the interior of the optical assembly 100. The influence of external stray light on the display effect is greatly reduced, the display quality is significantly improved and the user experience is improved.

For example, as shown in FIG. 5, the near-eye display device 1000 may be a virtual reality (VR) display device, a mixed reality (MR) display device, or the like. For example, the near-eye display device 1000 may be eyeglasses.

For example, the open-wearing near-eye display device means that a certain open space is left around or elsewhere in the lens so that the user's eyes are not completely isolated from the external environment when wearing the device. The open-wearing near-eye display devices not only reduce the weight and volume of the device, but also improve the comfort and aesthetics of wear.

In some examples, as shown in FIG. 5, the near-eye display device 1000 includes a lens 1010 including the optical assembly 100, and a temple 1020 including the light-transmitting assembly 200, the temple 1020 configured for being rotatable with respect to the lens 1010. Thus, the temple 1020 can move with the light-transmitting assembly 200 such that the light-transmitting assembly 200 is rotatable relative to the optical assembly 100 to facilitate adjustment of the relative positional relationship of the light-transmitting assembly 200 and the optical assembly 100. For example, the light-transmitting support 220 may be part of the temple 1020.

For example, as shown in FIG. 5, when the optical system is in a state of displaying an image, the human eyes 400 are located directly in front of the optical assembly 100, and the optical axis of the lens structure 110 does not pass through the light-transmitting assembly 200. The light-transmitting assembly 200 can be prevented from obstructing the image light incident on the human eyes 400 and affecting the user's viewing of the display screen. For example, the optical assembly 100 may be positioned directly in front of the human eyes 400. The light-transmitting assembly 200 may be positioned on both sides of the human eyes 400 to achieve polarization state conversion of ambient light directed to the optical assembly 100 on both sides of the human eyes 400 while the ambient light on both sides of the human eyes 400 is transmitted to the human eyes 400.

In some examples, as shown in FIG. 5, the lens 1010 includes two sub-lenses corresponding to two eyes 400 of the user. For example, the two sub-lenses may be lenses separated from each other, or may be a lens integrally arranged. The lens 1010 includes two sub-lenses corresponding to two eyes 400 of a user. The two sub-lenses may respectively be provided with one optical assembly 100. The centers of the two sub-lenses may be points on the optical axes of the lens structures 110 in the two optical assemblies 100.

For example, as shown in FIG. 5, the optical assemblies 100 are provided on both lenses 1010. The number of temples 1020 is two. The light-transmitting assemblies 200 are provided on both temples 1020 (the light-transmitting assembly on one temple is schematically shown in FIG. 5). The relative positional relationship between the light-transmitting assemblies 200 on both sides and the optical assemblies 100 provided on the lenses 1010 is substantially the same.

In some examples, as shown in FIG. 5, the temple 1020 includes a wearing portion 1022 and a widening portion 1021. The widening portion 1021 has a dimension greater than that of the wearing portion 1022 in a reference direction DO perpendicular to a center line CL of the two sub-lenses, of the lens 1010, corresponding to both eyes. The widening portion 1021 is located between the wearing portion 1022 and the lens 1010, the widening portion 1021 includes the light-transmitting assembly 200. The dimension, in the reference direction DO, of the widening portion 1021 may be the width of the widening portion 1021, and the dimension, in the reference direction DO, of the wearing portion 1022 may be the width of the wearing portion 1022. For example, the above-mentioned center line CL may be parallel to the center line of the two eyes of the user. For example, the widening portion 1021 may be the light-transmitting support 220 described above, and film layers, such as the first linear polarizing film 150, are provided on the widening portion 1021, for example, the film layers are attached to a side of the widening portion 1021 facing the human eye. The placement of film layers, such as the second linear polarizing film 210, are facilitated by adjusting the width of the portion of temple 1020 close to the lens 1010 to form the widening portion 1021.

For example, as shown in FIG. 5, the near-eye display device 1000 includes a frame surrounding the lens 1010, and the widening portion 1021 is connected to the frame. For example, the wearing portion 1022 is a portion that is placed on the ear when the user wears the near-eye display device 1000. For example, the widening portion 1021 and the wearing portion 1022 may be of an integrally provided structure, but are not limited thereto. The material of the widening portion 1021 may be different from that of the wearing portion 1022. For example, the widening portion 1021 is made of a light-transmitting material. The wearing portion 1022 may be made of a non-light-transmitting material. The wearing portion 1022 is inserted into the end of the widening portion 1021.

In some examples, as shown in FIG. 5, the ratio of the smallest dimension of the light-transmitting assembly 200 in the reference direction DO to the largest dimension of the lens region 1011 of the optical assembly 100 in the reference direction is in a range from 0.8 to 1.1. The smallest dimension of the light-transmitting assembly 200 in the extending direction of the widening portion 1021 is not less than the largest dimension of the lens region 1011 in the direction parallel to the center line. For example, neither the dimension of the widening portion 1021 in the reference direction DO and in the direction in which it extends is not less than the maximum dimension of the lens region 1011 in the corresponding direction.

The lens region 1011 may refer to a region where the image light is exited from the optical assembly 100. By setting the dimensional relationship between the light-transmitting assembly 200 and the lens region 1011 in the optical assembly 100, it is advantageous to prevent the widening portion 1021 from being oversized to affect the wearing effect while achieving that most of the external ambient light incident on both sides of the optical assembly 100 is light transmitted through the light-transmitting assembly 200.

For example, as shown in FIG. 5, the ratio of the smallest dimension of the light-transmitting assembly 200 in the reference direction DO to the largest dimension of the lens region 1011 of the optical assembly 100 in the reference direction is 0.9 to 1. For example, the shape of the lens region 1011 may be circular, and the largest dimension of the lens region 1011 may be the diameter of a circle. For example, the shape of the second linear polarizing film 210 in the light-transmitting assembly 200 may be a regular shape, such as a polygon, a curved polygon, etc. a quadrangle, a circle, an ellipse, etc. or an irregular shape. For example, the shape of the second linear polarizing film 210 in the light-transmitting assembly 200 may be set according to the shape of the widening portion 1021. For example, the shape of the light-transmitting assembly 200 may be rectangular. The smallest dimension of the light-transmitting assembly 200 in the reference direction DO may be one side length of the rectangle. The smallest dimension of the light-transmitting assembly 200 in the direction in which the widening portion 1021 extends may be the other side length of the rectangle.

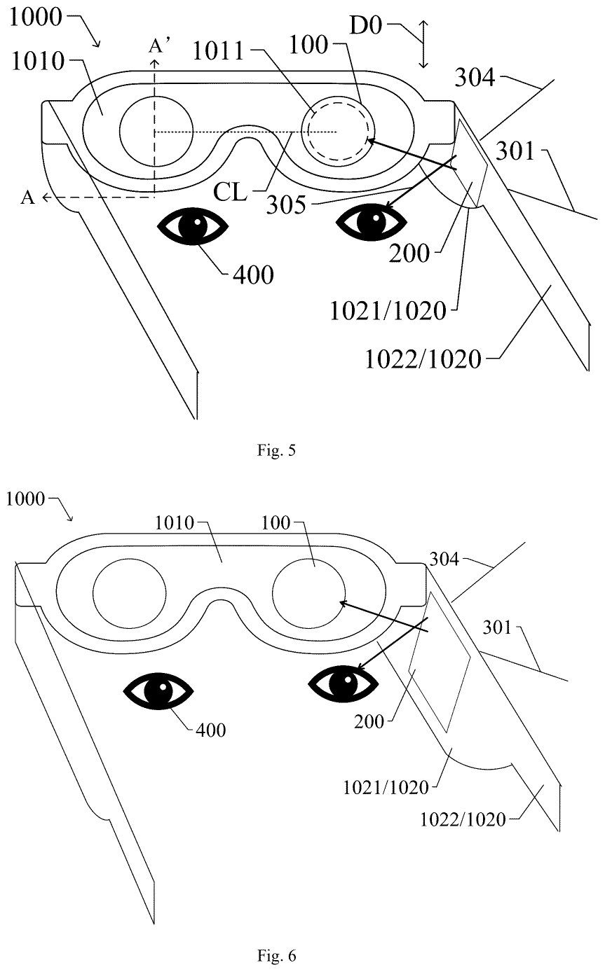

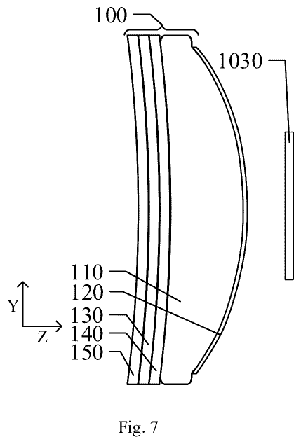

FIG. 6 is a schematic diagram of a near-eye display device provided according to another example of an embodiment of the present disclosure. The near-eye display device 1000 shown in FIG. 6 differs from the near-eye display device 1000 shown in FIG. 5 in that the widening portion 1021 has a different shape. For example, the length of the widening portion 1021 in the near-eye display device 1000 shown in FIG. 6 is greater than the length of the widening portion 1021 in the near-eye display device 1000 shown in FIG. 5. For example, the widening portion 1021 shown in FIG. 5 may be referred to as a little wing design in the temple 1020. For example, the widening portion 1021 shown in FIG. 6 may be referred to as a wide temple design.

For example, as shown in FIGS. 5 and 6, the ratio of the dimension of the widening portion 1021 to that of the wearing portion 1022 in the extending direction of the widening portion 1021 is in a range from ¼ to 1. By setting the ratio of the dimensions of the widening portion 1021 and the wearing portion 1022, it is possible to ensure that the user can wear the near-eye display device 1000, while the widening portion 1021 includes the light-transmitting assembly 200 whose dimensions meet certain requirements in order to achieve that the majority of the ambient light that is externally incident on the optical element 100 is the ambient light that passes through the light-transmitting assembly 200.

For example, as shown in FIGS. 5 and 6, the ratio of the dimension of the widening portion 1021 to that of the wearing portion 1022 in the direction in which the widening portion 1021 extends is ⅓ to ½. The embodiments of the present disclosure do not exemplify specific values of the ratio of the dimensions of the widening portion 1021 and the wearing portion 1022, and the ratio of the dimensions may be any value between ¼ and 1.

FIG. 7 is a structural diagram in a lens of FIG. 5.

In some examples, as shown in FIG. 7, the near-eye display device 1000 further includes a display screen 1030 located on a side of the beam splitting film 120 away from the first linear polarizing film 150.

For example, as shown in FIG. 7, the display surface of the display screen 1030 is located at a focal plane on the light incident side of the optical system.

For example, as shown in FIG. 7, the display screen 1030 may be any type of display screen, such as a liquid crystal display screen, an inorganic light emitting diode display screen, a quantum dot display screen, a projector (e. g., a LCOS micro-projector), etc.

The following statements should be noted:
(1) In the accompanying drawings of the embodiments of the present disclosure, the drawings involve only the structure(s) in connection with the embodiment(s) of the present disclosure, and other structure(s) can be referred to common design(s).
(2) In case of no conflict, features in one embodiment or in different embodiments can be combined.

What have been described above are only specific implementations of the present disclosure, the protection scope of the present disclosure is not limited thereto, and the protection scope of the present disclosure should be based on the protection scope of the claims.

1. An optical system, comprising:
an optical assembly, comprising a lens structure and a beam splitting film, a reflective polarizing film, a first phase retardation film and a first linear polarizing film provided on the lens structure, wherein the reflective polarizing film and the first phase retardation film are both located between the first linear polarizing film and the beam splitting film; image light transmitted through the beam splitting film is configured for being folded back between the beam splitting film and the reflective polarizing film and being exited from the reflective polarizing film; the lens structure comprises at least one optical lens;
a light-transmitting assembly, spaced apart from the optical assembly, wherein at least part of the light-transmitting assembly is located on a side of the first linear polarizing film away from the beam splitting film; the light-transmitting assembly is configured for transmitting different parts of external ambient light to human eyes and the optical assembly, respectively;
wherein the light-transmitting assembly comprises a second linear polarizing film; and an absorption axis of the second linear polarizing film is orthogonal to an absorption axis of the first linear polarizing film.

2. The optical system according to claim 1, wherein the optical assembly further comprises an anti-reflective film on the lens structure; and the anti-reflective film is located on a side of the first linear polarizing film away from the beam splitting film.

3. The optical system according to claim 1, wherein the light-transmitting assembly further comprises a light-transmitting support; and the second linear polarizing film is disposed on a side of the light-transmitting support facing the optical assembly.

4. The optical system according to claim 1, wherein the optical assembly further comprises a second phase retardation film located on the lens structure; the second phase retardation film is located on a side of the first linear polarizing film facing the second linear polarizing film; and an included angle between a slow axis of the second phase retardation film and an optical absorption axis of the first linear polarizing film is 45 degrees;
the light-transmitting assembly further comprises a third phase retardation film located on a side of the second linear polarizing film facing the second phase retardation film; and a slow axis of the third phase retardation film is orthogonal to the slow axis of the second phase retardation film.

5. The optical system according to claim 4, wherein the optical assembly further comprises an anti-reflective film on the lens structure; and the anti-reflective film is located on a side of the second phase retardation film away from the beam splitting film.

6. The optical system according to claim 4, wherein the light-transmitting assembly further comprises a light-transmitting support; and the second linear polarizing film and the third phase retardation film are both located on a side of the light-transmitting support facing the optical assembly.

7. The optical system according to claim 1, wherein the optical system is in a state of displaying an image; and an optical axis of the lens structure does not pass through the light-transmitting assembly.

8. The optical system according to claim 1, wherein the light-transmitting assembly is configured for being movable with respect to the optical assembly.

9. The optical system according to claim 3, wherein a light transmission of the light-transmitting support is greater than 95%.

10. The optical system according to claim 1, wherein an air space is provided between the optical assembly and the light-transmitting assembly.

11. The optical system according to claim 4, wherein the optical system is in a state of displaying an image, and an optical axis of the lens structure does not pass through the light-transmitting assembly;
the light-transmitting assembly is configured for being movable with respect to the optical assembly.

12. The optical system according to claim 6, wherein a light transmission of the light-transmitting support is greater than 95%.

13. A near-eye display device, comprising an optical system, the optical system comprising:
an optical assembly, comprising a lens structure and a beam splitting film, a reflective polarizing film, a first phase retardation film and a first linear polarizing film provided on the lens structure, wherein the reflective polarizing film and the first phase retardation film are both located between the first linear polarizing film and the beam splitting film; image light transmitted through the beam splitting film is configured for being folded back between the beam splitting film and the reflective polarizing film and being exited from the reflective polarizing film; the lens structure comprises at least one optical lens;
a light-transmitting assembly, spaced apart from the optical assembly, wherein at least part of the light-transmitting assembly is located on a side of the first linear polarizing film away from the beam splitting film; the light-transmitting assembly is configured for transmitting different parts of external ambient light to human eyes and the optical assembly, respectively;
wherein the light-transmitting assembly comprises a second linear polarizing film; and an absorption axis of the second linear polarizing film is orthogonal to an absorption axis of the first linear polarizing film;
the near-eye display device is an open-wearing near-eye display device.

14. The near-eye display device according to claim 13, wherein the near-eye display device comprises a lens and a temple; the lens comprises the optical assembly; the temple comprises the light-transmitting assembly; and the temple is configured for being rotatable with respect to the lens.

15. The near-eye display device according to claim 14, wherein the lens includes two sub-lenses corresponding to both eyes of a user; the temple comprises a wearing portion and a widening portion; a dimension of the widening portion is greater than a dimension of the wearing portion in a reference direction perpendicular to a center line of the two sub-lenses; and the widening portion is located between the wearing portion and the lens; and the widening portion includes the light-transmitting assembly.

16. The near-eye display device according to claim 15, wherein a ratio of a minimum dimension of the light-transmitting assembly in the reference direction to a maximum dimension of a lens region of the optical assembly in the reference direction is in a range from 0.8 to 1.1; and a minimum dimension of the light-transmitting assembly in an extending direction of the widening portion is not less than a maximum dimension of the lens region in a direction parallel to the center line.

17. The near-eye display device according to claim 16, wherein, in the extending direction of the widening portion, a ratio of a dimension of the widening portion to a dimension of the wearing portion is in a range from ¼ to 1.

18. The near-eye display device according to claim 13, further comprising a display screen located on a side of the beam splitting film away from the first linear polarizing film.

19. The near-eye display device according to claim 13, wherein the optical assembly further comprises a second phase retardation film located on the lens structure; the second phase retardation film is located on a side of the first linear polarizing film facing the second linear polarizing film; and an included angle between a slow axis of the second phase retardation film and an optical absorption axis of the first linear polarizing film is 45 degrees;
the light-transmitting assembly further comprises a third phase retardation film located on a side of the second linear polarizing film facing the second phase retardation film; and a slow axis of the third phase retardation film is orthogonal to the slow axis of the second phase retardation film.

20. The near-eye display device according to claim 13, wherein the optical assembly further comprises an anti-reflective film on the lens structure; and the anti-reflective film is located on a side of the first linear polarizing film away from the beam splitting film;
the light-transmitting assembly further comprises a light-transmitting support; and the second linear polarizing film is disposed on a side of the light-transmitting support facing the optical assembly.
